(19) United States
(12) Patent Application Publication
(10) Pub. No.: US 2007/0057060 A1
(43) Pub. Date: Mar. 15, 2007

(54) Scanner apparatus and arrangement reproduction method

(75) Inventor: Kimitake Hasuike, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuij Xerox Co., Ltd

(21) Appl. No.: 11/348,504

(22) Filed: Feb. 7, 2006

(30) Foreign Application Priority Data
Sep. 14, 2005 (JP) P2005-267373

(51) Int. Cl. G06K 7/10

(52) U.S. Cl. 235/454

(57) ABSTRACT

An arrangement reproduction method includes: reading a first code image on a first medium and a second code image on a second medium arranged on the first medium; recognizing an arrangement range in which the second medium is arranged on the first medium using the first code image and the second code image; and reproducing on an electronic space the arrangement relationship between the first medium and the second medium including the recognized arrangement range.

### BACKGROUND OF THE INVENTION

1. Field of the Invention

The present invention relates to an art of reading information from a code image printed on a medium such as paper and processing the information.

2. Description of the Related Art

In recent years, attention has been focused on an art for enabling the user to draw characters or a picture on special paper with fine dots printed thereon and transfer data of the characters, etc., written on the paper to a personal computer, a mobile telephone, etc., for retaining the data and executing mail transmission. In this art, small dots are printed on the special paper with a spacing of about 0.3 mm, for example, so as to draw different patterns for each grid of a predetermined size, for example. The paper is read with a dedicated pen incorporating a digital camera, for example, whereby the positions of the characters, etc., written on the special paper can be determined and it is made possible to use such characters, etc., as electronic information.

An art of printing an electronically stored document on a paper sheet provided with a position coding pattern is available as a related in this art, a special paper sheet provided with a position coding pattern is also used. A document is printed on the paper sheet, manual edit is executed on the paper sheet using a digital pen including position coding pattern read unit and a pen point for marking the paper surface, and the edit result is reflected on electronic information. The related art also describes that it is desirable that document information should be printed together with the position coding pattern.

By the way, in brainstorming, etc., a plurality of labels on which notes of various ideas are taken may be put on paper for examining the ideas. However, if the user wants to electronize information of such notes taken on labels, hitherto, it has been possible only to read paper on which the labels were put through a scanner or to photograph paper on which the labels were put with a digital camera, and it has been difficult even to recognize which part of the electronized information is a label; this is a problem.

If information containing labels is thus electronized using a scanner or a digital camera, a label and paper on which the label is put are processed as one image. Therefore, the label and the paper as the electronic information cannot separately be handled; this is also a problem. For example, work of moving or deleting the label only as the electronic information separately from the paper may become necessary, but such work cannot be accomplished in related arts.

To solve the problems, the art described above does not provide any effective solution means. That is, in the art described above, document information with position coding patterns is only printed and a label put on document information is not recognized.

The problems can occur not only with labels, but also with seals, etc. Hereinafter, media that can be put on paper, such as a label and a seal, will be collectively called “adhesive material” and a medium on which the adhesive material can be put will be called “base material.”

### SUMMARY OF THE INVENTION

The present invention has been made in view of the above circumstances and provides scanner apparatus and arrangement reproduction method.

According to the present invention, there is provided at least one of the following configurations.

An arrangement reproduction method including: reading a first code image on a first medium and a second code image on a second medium arranged on the first medium; recognizing an arrangement range in which the second medium is arranged on the first medium using the first code image and the second code image; and reproducing on an electronic space the arrangement relationship between the first medium and the second medium including the recognized arrangement range.

A scanner apparatus including: an input section for inputting first information printed on a first medium containing position information within the first medium and second information printed on a second medium arranged on the first medium; and a processing section that recognizes an arrangement range in which the second medium is arranged on the first medium the using position information of a discontinuous portion between the first information and the second information.

A storage medium readable by a computer, the storage medium storing a program of instructions executable by the computer to perform a function, the function including: inputting code information printed on a base material on which an adhesive material is arranged; and recognizing an arrangement range in which the adhesive material is arranged on the base material using position information of a part where continuity of the code information is interrupted, by arrangement of the adhesive material on the base material.

A storage medium readable by a computer, the storage medium storing a program of instructions executable by the computer to perform a function, the function including: acquiring position information on a first medium at an edge of a second medium arranged on a first medium; calculating an arrangement range in which the second medium is arranged on the first medium based on the position information; and

arranging a second object representing the second medium in a range corresponding to the arrangement range on a first object representing the first medium.

A storage medium readable by a computer, the storage medium storing a program of instructions executable by the computer to perform a function, the function including: acquiring first information indicating the position on a first medium of at least one point on an edge of a second medium arranged on the first medium, second information indicating a size of the second medium, and third information indicating an inclination of the second medium relative to the first medium; calculating an arrangement range in which the second medium is arranged on the first medium based on the first information, the second information, and the third information; and arranging a second object representing the second medium in a range corresponding to the arrangement range on a first object representing the first medium.

### BRIEF DESCRIPTION OF THE DRAWINGS

In the accompanying drawings:

FIG. 1 is a drawing to show the general configuration of a system incorporating an embodiment;

FIGS. 2A-2D are drawings to describe an outline of the processing flow in the embodiment;

FIGS. 3A-3C are drawings to describe a two-dimensional code image printed on a medium in a first embodiment;

FIG. 4 is a drawing to show the configuration of a read device used to read a code image in the first embodiment;

FIG. 5 is a drawing to describe a code image grasping method in the first embodiment;

FIG. 6 is a flowchart to show the operation of a processor of the read device in the first embodiment;

FIGS. 7A and 7B are drawings to describe an information read method in the first embodiment;

FIG. 8 is a drawing to show an example of data stored in memory by the processor in the first embodiment;

FIG. 9 is a block diagram to show the configuration of a terminal for displaying objects in the first embodiment;

FIG. 10 is a flowchart to show the operation of an object generation section in the terminal in the first embodiment;

FIGS. 11A-11C are drawings to describe a two-dimensional code image printed on a medium in a second embodiment;

FIG. 12 is a drawing to show the configuration of a pen device used to read a code image in the second embodiment;

FIG. 13 is a drawing to describe a code image grasping method in the second embodiment;

FIG. 14 is a flowchart to show the operation of a control section of the pen device in the second embodiment;

FIG. 15 is a drawing to show an example of data stored by the control section in memory by the processor in the second embodiment;

FIG. 16 is a block diagram to show the configuration of a terminal for displaying objects in the second embodiment; and

FIG. 17 is a flowchart to show the operation of a boundary calculation section and an object generation section in the terminal in the second embodiment

### DETAILED DESCRIPTION OF THE INVENTION

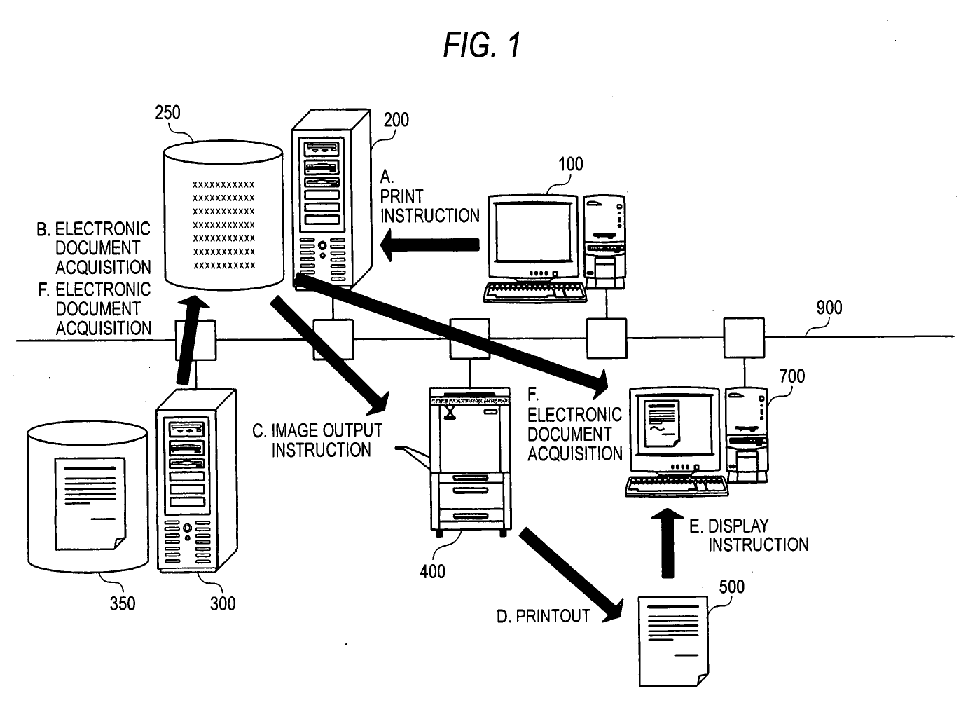

FIG. 1 shows a configuration example of a system according to an embodiment. This system includes at least a terminal 100 for issuing a print instruction to print an electronic document, an identification information management server 200 for managing identification information given to a medium in printing an electronic document and generating an image having a code image containing the identification information, etc., superposed on the image of the electronic document, a document management server 300 for managing electronic documents, and an image formation apparatus 400 for printing an image having a code image superposed on an image of an electronic document, the components 100, 200, 300, and 400 being connected to a network 900.

An identification information repository 250 as storage for storing identification information is connected to the identification information management server 200, and a document repository 350 as storage for storing electronic documents is connected to the document management server 300.

Further, the system includes printed material 500 output on the image formation apparatus 400 as instructed from the terminal 100 and a terminal 700 for superposing an electronic document printed on the printed material 500 and handwritten characters, etc., written onto printed material 500 for display.

The expression “electronic document” used throughout the Specification means not only electronized data of a “document” containing text, but also image data of a picture, a photo, a graphic form, etc., (regardless of raster data or vector data) and any other printable electronic data, for example.

An outline of the operation of the system will be discussed.

First, the terminal 100 instructs the identification information management server 200 to superpose a code image on an image of an electronic document managed in the document repository 350 and print (A). At this time, from the terminal 100, the print attributes of the paper size, the orientation, the number of sheets, scale-down/scale-up, N-up (print with N pages of electronic document laid out within one page of paper), duplex printing, etc., are also input. Accordingly, the identification information management server 200 acquires the electronic document whose printing is instructed from the document management server 300 (B). The identification information management server 200 gives a code image containing the identification information managed in the identification information repository 250 and position information determined as required to the image of the acquired electronic document, and instructs the image formation apparatus 400 to print (C). The identification information is information for uniquely identifying each medium (paper) on which the image of the electronic document is printed, and the position information is information for determining the coordinate position (X coordinate, Y coordinate) on each medium.

Next, the image formation apparatus 400 outputs printed material 500 in accordance with the instruction from the identification information management server 200 (D). The image formation apparatus 400 forms the code image given by the identification information management server 200 using roughly invisible toner having a high absorption rate of infrared light. On the other hand, the image formation apparatus 400 forms any other image (image in the portion contained in the original electronic document) using visible toner having a low absorption rate of infrared light.

Then, the user performs read operation of information from the code image printed on the printed material 500, thereby giving a display instruction of the electronic document as the source of the image printed on the printed material 500 (E). Accordingly, the terminal 700 transmits a request for acquiring the electronic document to the identification information management server 200 and acquires the electronic document managed in the document management server 300 through the identification information management server 200 (F).

At the time, the information may be read from the printed material 500 using a device capable of reading the whole of the printed material 500 or may be read using a pen device capable of reading a part of the printed material 500. In the Specification, the former device is particularly called “read device” and the latter is called pen device intact.

In the embodiment, the printed material 500 is used as a base material and a adhesive material is put thereon and the base material and the adhesive material are displayed on the terminal 700 in a form in which they can be distinguished from each other although not shown in FIG. 1.

However, such a configuration is only an example. For example, one server may be provided with both the function of the identification information management server 200 and the function of the document management server 300. The function of the identification information management server 200 may be implemented in an image processing section of the image formation apparatus 400. Further, the terminals 100 and 700 may be configured as a single terminal.

Next, an outline of the embodiment will be discussed. In the description to follow, the adhesive material is a label by way of example.

In the embodiment, a code-added document 510 and a label 520 are output in D in FIG. 1.

A document image of an electronic document and a code image containing identification information, position information, etc., are printed on the code-added document 510. At printing, the correspondence between the identification information and the electronic document is stored in the identification information management server 200, for example, for making it possible to keep track of which electronic document is printed on which medium.

A code image containing identification information, position information, etc., is printed on the label 520, but the document image of the electronic document is not printed thereon. Therefore, the identification information is managed for preventing dual delivery thereof, but is not managed in association with the electronic document.

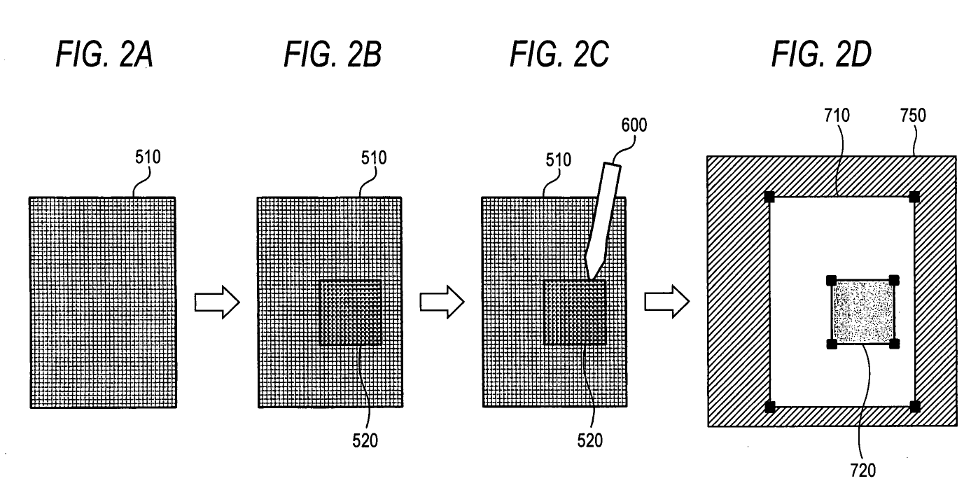

FIGS. 2A-2D show an outline of the processing flow in the embodiment.

FIG. 2A shows the above-mentioned code-added document 510. The code image is shown in shaded.

Next, the label 520 is put on the code-added document 510, as shown in FIG. 2B. Here, the information represented by the code image printed on the code-added document 510 and the information represented by the code image printed on the label 520 are not continuous. The fact that the information is thus discontinuous on the boundary between the code-added document 510 and the label 520 is represented by different densities of the shading in the figure.

In this state, the user reads the boundary between the code-added document 510 and the label 520 using a pen device 600, for example, as shown in FIG. 2C. Accordingly, a document object 710 of an electronic object representing the code-added document 510 and a label object 720 of an electronic object representing the label 520 are displayed on a display 750 of the terminal 700 so as to reproduce the actual positional relationship between the code-added document 510 and the label 520, as shown in FIG. 2D.

FIGS. 2A-2D show the method of reading the boundary between the code-added document 510 and the label 520 using the pen device 600; however, it is also possible to use a read device capable of reading the whole of the code-added document 510 on which the label 520 is put for read, as described above.

Therefore, the configuration and the operation from recognition of the boundary between the code-added document 510 and the label 520 to generation and display of the document object 710 and the label object 720 will be discussed below in detail with the case where the read device is used for read as a first embodiment and the case where the pen device 600 is used for read as a second embodiment.

### First Embodiment

First, a code image used in the first embodiment will be discussed.

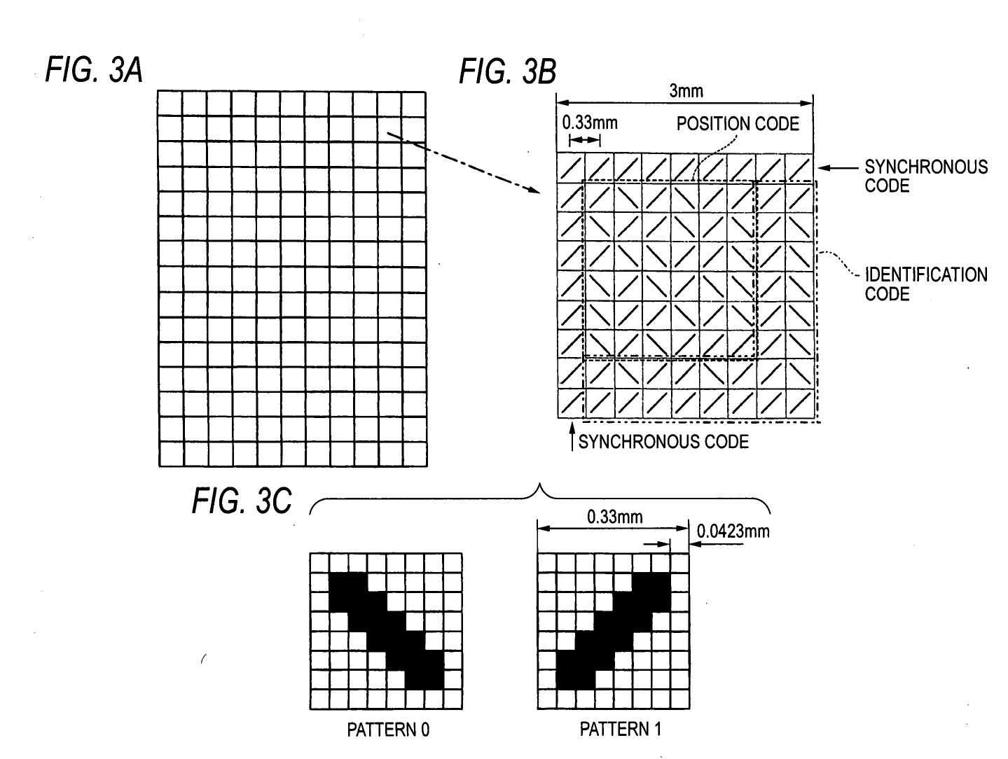

FIGS. 3A-3C are drawings to describe a two-dimensional code image printed on the printed material 500 in the first embodiment. FIG. 3A is a drawing represented like a lattice to schematically show the units of a two-dimensional code image formed of an invisible image and placed. FIG. 3B is a drawing to show one unit of the two-dimensional code image (simply, “two-dimensional code”) whose invisible image is recognized by infrared application. Further, FIG. 3C is a drawing to describe slanting line patterns of a backslash and a slash.

In the embodiment, the two-dimensional code image is formed of invisible toner with the maximum absorption rate in a visible light region (400 nm to 700 nm) being 7% or less, for example, and the absorption rate in a near infrared region (800 nm to 1000 nm) being 30% or more, for example. The invisible toner with an average dispersion diameter ranging from 100 nm to 600 nm is adopted to enhance the near infrared light absorption capability required for mechanical read of an image. Here, the terms “visible” and “invisible” do not relate to whether or not visual recognition can be made. The terms “visible” and “invisible” are distinguished from each other depending on whether or not an image formed on a printed medium can be recognized depending on the presence or absence of color development caused by absorption of a specific wavelength in a visible light region.

The two-dimensional code image is formed as an invisible image for which mechanical read by infrared application and decoding processing can be performed stably over a long term and information can be recorded at a high density. Preferably, the two-dimensional code image is an invisible image that can be provided in any desired area independently of the area where a visible image on the medium surface for outputting an image is provided. In the embodiment, the invisible image is formed on a full face of one side of a medium (paper face) matched with the size of a printed medium. Furthermore preferably, it is an invisible image that can be recognized based on a gloss difference in visual inspection. However, the expression “full face” is not used to mean the full face containing all four corners of paper. With an apparatus such as an electrophotographic apparatus, usually the margins of the paper face are often in an unprintable range and therefore an invisible image need not be printed in the range.

The two-dimensional code shown in FIG. 3B contains an area to store a position code indicating the coordinate position on the medium and an area to store an identification code for uniquely identifying the print medium. It also contains an area to store a synchronous code. As shown in FIG. 3A, a plurality of the two-dimensional codes are placed like a lattice on one side of the medium (paper face). That is, a plurality of two-dimensional codes as shown in FIG. 3B are placed on one side of the medium, each including a position code, an identification code, and a synchronous code. Different pieces of position information are stored in the areas of the position codes depending on the place where the position code is placed. On the other hand, the same identification information is stored in the identification code areas independently of the place where the identification code is placed.

In FIG. 3B, the position code is placed in a 6-bit×6-bit rectangular area. The bit values are formed as minute line bit maps different in rotation angle and slanting line patterns (patterns 0 and 1) shown in FIG. 3C represent bit values 0 and 1. More specifically, bits 0 and 1 are represented using a backslash and a slash which are different in inclination. Each slanting line pattern is of a size of 8×8 pixels in 600 dpi; the slanting line pattern lowering to the right (pattern 0) represents the bit value 0 and the slanting line pattern rising to the right (pattern 1) represents the bit value 1. Therefore, one slanting line pattern can represent 1-bit information (0 or 1). Using such minute line bit maps involving two types of inclinations, it is made possible to provide two-dimensional code patterns with extremely small noise given to a visible image, the two-dimensional code patterns in which a large amount of information can be digitized and embedded at a high density.

That is, 36-bit position information is stored in the position code area shown in FIG. 3B. Of the 36 bits, 18 bits can be used to code X coordinates and 18 bits can be used to code Y coordinates. If the 18 bits for the X coordinates and those for the Y coordinates are all used for coding positions, 218 (about 260000) positions can be coded. When each slanting line pattern is formed of 8×8 pixels (600 dpi) as shown in FIG. 3C, the size of the two-dimensional code (containing the synchronous code) in FIG. 3B becomes about 3 mm in length and about 3 mm in width (8 pixels×9 bits×0.0423 mm) because one dot of 600 dpi is 0.0423 mm. To code 260000 positions with a 3-mm spacing, a length of about 786 m can be coded. All 18 bits may be thus used to code positions or if a detection error of a slanting line pattern occurs, a redundancy bit for error detection and error correction may be contained.

The identification code is placed in 2-bit×8-bit and 6-bit×2-bit rectangular areas and 28-bit identification information can be stored. To use 28 bits as the identification information, 2²⁸ (about 270 million) pieces of identification information can be represented. A redundancy bit for error detection and error correction can be contained in the 28 bits of the identification code like the position code.

In the example shown in FIG. 3C, the two slanting line patterns differ in angle 90 degrees, but if the angle difference is set to 45 degrees, four types of slanting line patterns can be formed. In doing so, one slanting line pattern can represent 2-bit information (any of 0 to 3). That is, as the number of angle types of slanting line patterns is increased, the number of bits that can be represented can be increased.

In the example shown in FIG. 3C, coding of the bit values is described using the slanting line patterns, but the patterns that can be selected are not limited to the slanting line patterns. A coding method of dot ON/OFF or a coding method depending on the direction in which the dot position is shifted from the reference position can also be adopted.

Next, the specific configuration and operation of the embodiment will be discussed.

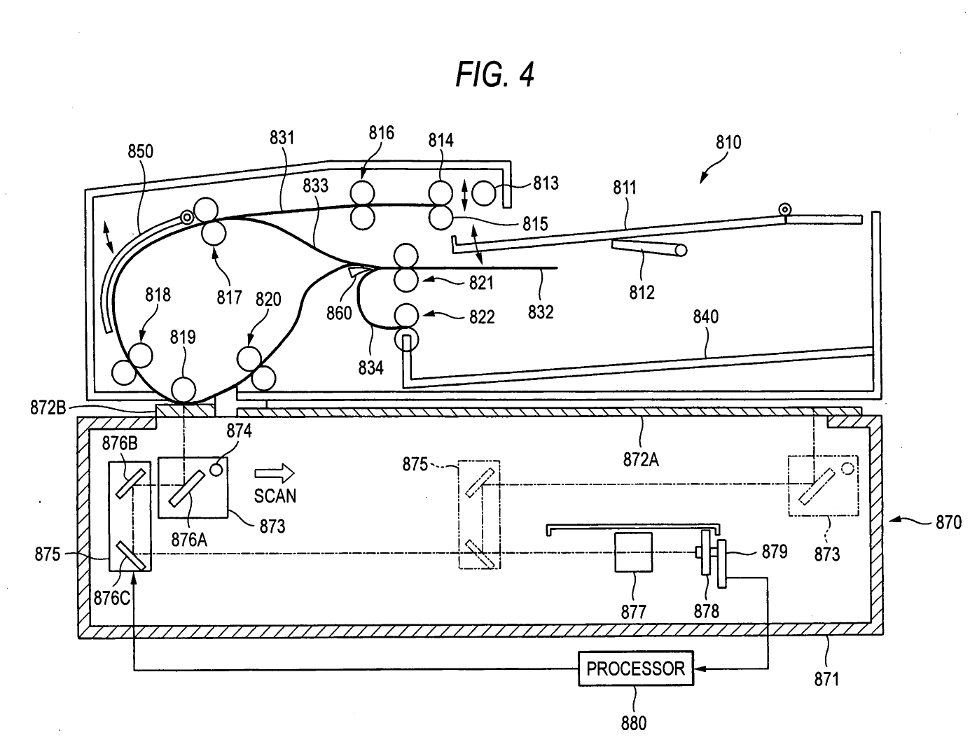

FIG. 4 is a drawing to show the configuration of the read device in the embodiment.

The read device is roughly made up of a document feeder 810 for transporting an original document one at a time out of a stacked document bundle, a scanner 870 for reading an image by scanning, and a processor 880 for performing drive control of the document feeder 810 and the scanner 870 and processing an image signal read by the scanner 870.

The document feeder 810 includes a document tray 811 on which an original document bundle made up of a plurality of documents can be stacked and a tray lifter 812 for moving up and down the document tray 811. The document feeder 810 also includes a nudger roll 813 for transporting an original on the document tray 811 moved up by the tray lifter 812, a feed roll 814 for transporting furthermore downstream the original transported by the nudger roll 813, and a retard roll 815 for handling the originals supplied by the nudger roll 813 one at a time. A first transport passage 831 where an original is first transported involves 25 a take away roll 816 for transporting the original handled to one at a time to a downstream roll, a preregistration roll 817 for transporting the original a furthermore downstream roll and forming a loop, a registration roll 818 for once stopping and then restarting rotation timely and supplying the original document while performing registration adjustment to the document read section, a platen roll 819 for assisting transporting the original being read, and an out roll 820 for transporting the read original furthermore downstream. The first transport passage 831 is also provided with a baffle 850 for rotating on a supporting point in response to the loop state of the transported original document.

Provided downstream from the out roll 820 is a second transport passage 832 placed below the document tray 811 for introducing the original document into an ejection tray 840 for stacking the original document whose read is complete. A first ejection roll 821 for ejecting the original document to an ejection tray 840 is attached to the second transport passage 832. The first ejection roll 821 is rotated in normal and reverse directions to transport the original also in the opposite direction as described later.

The document feeder 810 is also provided with a third transport passage 833 for inverting and transporting the original document whose read is complete so that images on both sides can be read in one process in reading an original document formed with images on both sides. The third transport passage 833 is provided between the entry of the first ejection roll 821 and the entry of the preregistration roll 817. Further, the document feeder 810 is provided with a fourth transport passage 834 for once more inverting the original document whose read is complete on both sides and then ejecting the original document to the ejection tray 840 when both sides of the original document are read. The fourth transport passage 834 is formed so as to branch downward from the entry of the first ejection roll 821, and a second ejection roll 822 for ejecting the original to the ejection tray 840 is attached to the fourth transport passage 834. At the branch part of the third transport passage 833 and the fourth transport passage 834, a transport passage switching gate 860 is provided for switching between the transport passages.

In the described configuration, the nudger roll 813 is lifted up and is held at a retreat position in a standby mode and drops to a nip position (original transport position) at the original transport time for transporting the top original document on the document tray 811. The nudger roll 813 and the feed roll 814 transport the original document by joining a feed clutch (not shown). The preregistration roll 817 abuts the leading end of the original document against the registration roll 818 which stops, and forms a loop. At the registration roll 818, when the loop is formed, the leading end of the original nipped in the registration roll 818 is restored to the nip position. When the loop is formed, the baffle 850 opens with the supporting point as the center and functions so as not to hinder the original loop. The take away roll 816 and the preregistration roll 817 holds the loop during reading. As the loop is formed, the read timing can be adjusted and a skew accompanying the original transport at the read time can be suppressed for enhancing the adjustment function of registration. The registration roll 818 which stops starts to rotate at the read start timing and the original document is pressed against second platen glass 872b (described later) by the platen roll 819 and the image data is read from the lower face (side) direction.

In the read device, in a single side mode for reading an image on one side of the original document, the original document whose read is complete on one side is introduced from the first transport passage 831 into the second transport passage 832 and is ejected to the ejection tray 840 by the first ejection roll 821.

On the other hand, in a double side mode for reading images on both sides of the original document, the original document whose read is complete on one side (first side) is introduced from the first transport passage 831 into the second transport passage 832 and is further transported by the first ejection roll 821. The transport passage switching gate 860 is switched so as to introduce the original document into the third transport passage 833 at the timing just after the trailing end of the original in the transport direction passes through the transport passage switching gate 860, and the rotation direction of the first ejection roll 821 is switched to the opposite direction. Consequently, the original document is introduced from the second transport passage 832 again into the first transport passage 831 with the original document turned over. The original document whose read is complete on the other side (second side) is introduced from the first transport passage 831 into the second transport passage 832 and is further transported by the first ejection roll 821. Then, the transport passage switching gate 860 is switched so as to introduce the original document into the fourth transport passage 834 at the timing just after the trailing end of the original document in the transport direction passes through the transport passage switching gate 860, and the rotation direction of the first ejection roll 821 is again switched to the opposite direction. Consequently, the original document is introduced from the second transport passage 832 into the fourth transport passage 834 with the original document further turned over, and is ejected to the ejection tray 840 by the second ejection roll 822.

As the configuration is adopted, in the document feeder 810 according to the embodiment, the original document whose image read is complete can be stacked on the ejection tray 840 in a state in which the relation between the inside and the outside of the original document is the same as that when the original document is set on the document tray 811 regardless of the single side mode or the double side mode.

Next, the scanner 870 will be discussed.

The scanner 870 supports the above-described document feeder 810 on a frame 871 and reads the image of the original document transported by the document feeder 810. The scanner 870 is provided with first platen glass 872A for placing the original document whose image is to be read in a still state and the above-mentioned second platen glass 872B for forming a light opening to read the original document being transported by the document feeder 810. In the embodiment, the document feeder 810 is attached to the scanner 870 so as to be swingable with the depth as a supporting point and to set the original document on the first platen glass 872A, the user lifts up the document feeder 810 and places the original document and then drops the document feeder 810 onto the scanner 870 to press the original document.

The scanner 870 also includes a full rate carriage 873 being still below the second platen glass 872B and for scanning over the whole of the first platen glass 872A for reading the image and a half rate carriage 875 for giving light obtained from the full rate carriage 873 to an image coupling section. The full rate carriage 873 is provided with an illuminating lamp 874 for applying light to the original document and a first mirror 876A for receiving reflected light obtained from the original document. The illuminating lamp 874 applies light containing near infrared light for reading a code image.

The half rate carriage 875 is provided with a second mirror 876B and a third mirror 876C for giving light obtained from the first mirror 876A to an image formation section. Further, the scanner 870 includes an image forming lens 877 for optically reducing an optical image obtained from the third mirror 876C, a CCD (Charge-Coupled Device) image sensor 878 for executing photoelectric conversion of the optical image formed through the image forming lens 877, and a drive board 879 to which the CCD image sensor 878 is attached, and an image signal provided by the CCD image sensor 878 is sent through the drive board 879 to the processor 880. The CCD image sensor 878 has sensitivity also to near infrared light for reading a code image.

In the embodiment, the full rate carriage 873, the illuminating lamp 874, the half rate carriage 875, the first mirror 876A, the second mirror 876B, the third mirror 876C, the image forming lens 877, the CCD image sensor 878, and the drive board 879 serve as a read unit. In the description of the embodiment, the CCD optical system as the optical system of the scanner 870 is used by way of example, but a scanner using any other system, for example, an optical system of CIS, etc., may be used.

For reading a fixed original document placed on the first platen glass 872A, the full rate carriage 873 and the half rate carriage 875 move in the scan direction (arrow direction) at a ratio of 2 to 1. At this time, light of the illuminating lamp 874 of the full rate carriage 873 is applied to the read side of the original document and the reflected light from the original document is reflected on the first mirror 876A, the second mirror 876B, and the third mirror 876C in order and is introduced into the image forming lens 877. The light introduced into the image forming lens 877 is focused on the light reception face of the CCD image sensor 878. A line sensor provided in the CCD image sensor 878 is a one-dimensional sensor for processing one line at a time. When read of one line in the line direction (main scanning direction) is complete, the full rate carriage 873 is moved in the direction orthogonal to the main scanning direction (subscanning direction) and the next line of the original document is read. This sequence is executed over the whole original document size, whereby the one-page original document read is completed.

On the other hand, the second platen glass 872B is formed of a transparent glass plate having a long plate-like structure, for example. For original document flow read of reading the image of an original document transported by the document feeder 810, the original document transported by the document feeder 810 passes through on the top of the second platen glass 872B. At this time, the full rate carriage 873 and the half rate carriage 875 are in a state in which they stop at the positions indicated by the solid lines in FIG. 4. First, reflected light on the first line of the original document passing through the platen roll 819 of the document feeder 810 passes through the first mirror 876A, the second mirror 876B, and the third mirror 876C and is focused in the image forming lens 877 and the image is read by the CCD image sensor 878. That is, the line sensor of the one-dimensional sensor provided in the CCD image sensor 878 processes one line in the main scanning direction at a time and then reads the next one line in the main scanning direction of the original document transported by the document feeder 810. After the leading end of the original document arrives at the read position of the second platen glass 872B, the original document passes through the read position of the second platen glass 872B, whereby the one-page read over the subscanning direction is completed.

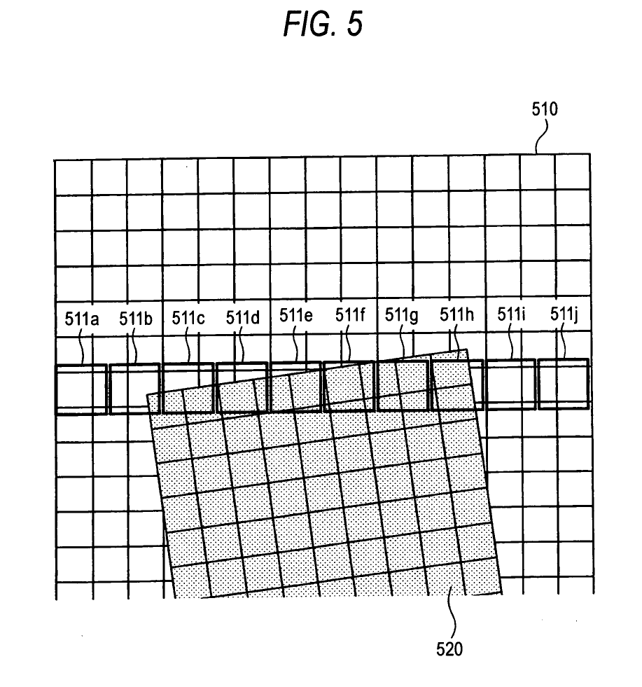

Boundary recognition processing when the read device is used will be discussed with reference to a specific example in FIG. 5.

FIG. 5 shows a state in which the label 520 is put on the code-added document 510. Here, the label 520 is shaded. The label 520 usually is put in an offhand manner and thus is drawn with a slight inclination (angle) relative to the code-added document 510. Each of the partitions provided in the code-added document 510 and the label 520 indicates the range of the two-dimensional code containing the synchronous code, the identification code, and the position code shown in FIG. 3B.

In the embodiment, the boundary between the code-added document 510 and the label 520 is grasped as shown in the figure. That is, images in ranges 511a to 511j are read in order. In the embodiment, however, the read device scans over the full face of the code-added document 510 and thus the ranges 511a to 511j indicate the read range in the main scanning direction with attention focused on one line in the subscanning direction.

The boundary recognition method in the embodiment is performed as follows.

Which of the code-added document 510 and the label 520 exists in each range is determined from the identification information recognized in each range. The position where the identification information representing the code-added document 510 switches to that representing the label 520 or the identification information representing the label 520 switches to that representing the code-added document 510 is recognized as the boundary between the code-added document 510 and the label 520.

Putting the label 520 on the code-added document 510 at a given angle can normally occur as described above. In this case, the angle needs to be corrected for reading information. Generally, the angle does not become so large and thus can be corrected according to an algorithm for correcting a minute angle when code (glyph) as shown in FIGS. 3B and 3C is used. In this method, roughly a search is made sequentially for a dark pixel at a distance equal to the glyph pitch from the origin and it is determined that the direction is an angle shift. This correction is described in detail in JP-A-2001-312733 that claims priority on three U.S. patent applications Ser. No. 09/454,526, No. 09/455,304, and No. 09/456,105.

However, depending on the scan range, it is also considered that the code image of the code-added document 510 and the code image of the label 520 having a given angle may be mixed in the scan range. In this case, it is difficult to correct the angle using the technique in JP-A-2001-312733 and thus processing is advanced by assuming that it is impossible to correct the angle in such a range.

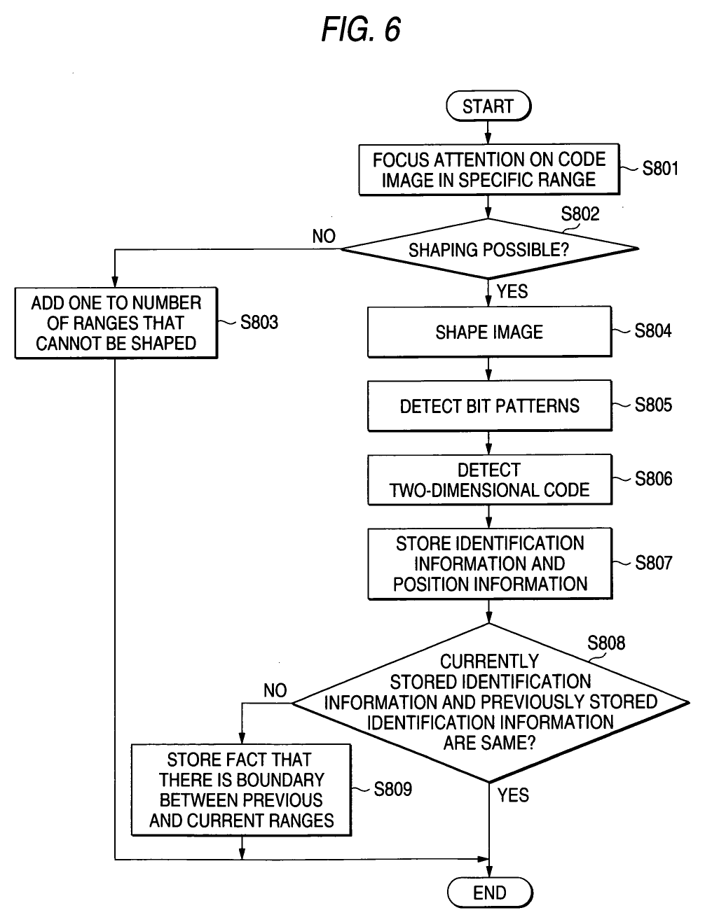

FIG. 6 is a flowchart to show the operation of the processor 880 (see FIG. 4).

First, the processor 880 focuses attention on a code image in a specific range (step 801). That is, image read is executed in a plurality of ranges in sequence as shown in FIG. 5, but the flowchart shows processing applies to one of the ranges.

Next, the processor 880 determines whether or not the code image on which attention is focused can be shaped (step 802). Here, although the shaping includes angle correction, noise removal, etc., particularly whether or not it is impossible to correct the angle as the code-added document 510 and the label 520 are mixed in one range is determined.

If it is determined that shaping is impossible, one is added to the number of ranges that cannot be shaped (step 803). That is, letting a variable storing the number of ranges that cannot be shaped be e, the variable e represents the number of consecutive ranges determined where shaping is impossible.

On the other hand, if it is determined that shaping is possible, the processor 880 shapes the image (step 804). The processor 880 detects bit patterns (slanting line patterns) of slash, backslash and the like, from the shaped scan image (step 805). The processor 880 detects a two-dimensional code from the shaped scan image by detecting and referencing the synchronous code of the positioning code (step 806). Then, the processor 880 extracts and decodes information of ECC (Error Correction Code), etc., from the two-dimensional code and extracts identification information and position information from the decoded information and stores the identification information and the position information in memory (step 807). A specific extracting method of the identification information and the position information from the scan image is described later.

Since the identification information and the position information are also extracted and are stored in the memory by similar processing from the immediately preceding range, whether or not the currently stored identification information and the previously stored identification information are the same is determined (step 808). The term “previous (ly)” is used to means the previous process range except the ranges that cannot be shaped.

If the currently stored identification information and the previously stored identification information are not the same, the fact that there is a boundary between the previous range and the current range is stored in the memory (step 809). At the time, if the previous range is on the code-added document 510 and the current range is on the label 520, the boundary position is also found based on the previous position information and the previous position information and the found boundary position is stored. On the other hand, if the previous range is on the label 520 and the current range is on the code-added document 510, the boundary position is found based on the current position information and the following position information. To put the label 520 on the code-added document 510, usually the area of the code-added document 510 surrounds the area of the label 520 and therefore it can be determined that the target range is on the code-added document 510 if it is outside the boundary; it can be determined that the target range is on the label 520 if it is inside the boundary.

On the other hand, if the currently stored identification information and the previously stored identification information are the same, both the previous and current ranges exist on the code-added document 510 or the label 520 and therefore the processing in the current range is terminated.

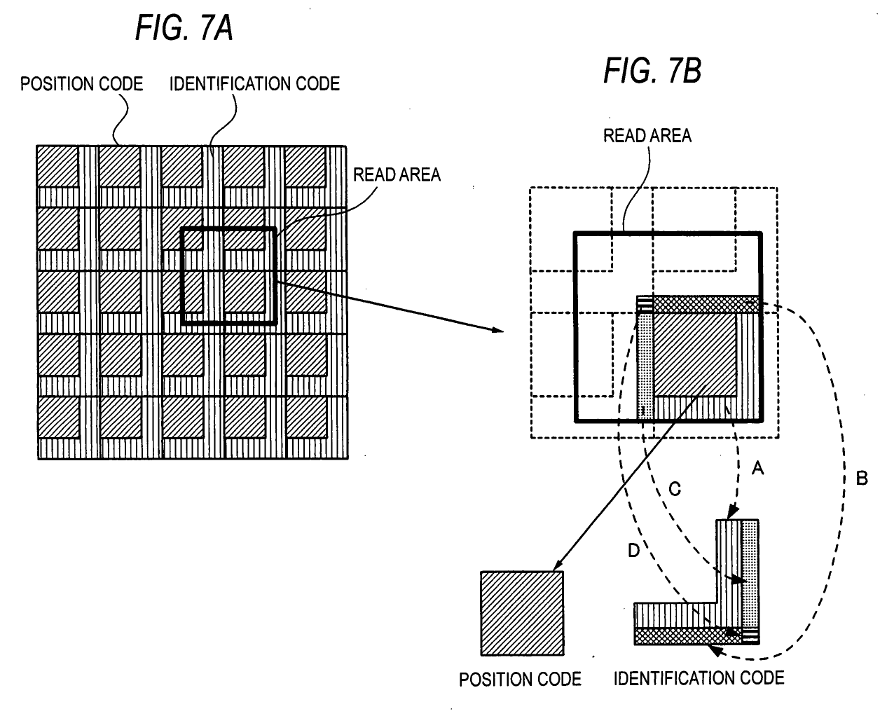

FIGS. 7A and 7B are drawings to describe code information read in the pen device 600. As shown in FIG. 7A, a plurality of position codes (corresponding to position information) and a plurality of identification codes (corresponding to identification information) are placed two-dimensionally on a printed medium. In FIG. 7A, the synchronous code is not shown for convenience of the description. Different pieces of position information are stored in the position codes depending on the place where the position code is placed, and the same identification information is stored in the identification codes independently of the place where the identification code is placed, as described above. Now, assume that the code image read area is indicated by the heavy line in FIG. 7A. FIG. 7B is an enlarged drawing of the read area proximity. Since different information is stored in the position code depending on the place in the image, the position code can be detected only if the read image contains one or more position codes. However, the same identification information is all stored in the identification codes independently of the place in the image and thus the identification code can be restored from fragmentary information. In the example shown in FIG. 7B, four partial codes in the read area (A, B, C, and D) are combined to restore one identification code.

Next, the processing shown in FIG. 6 will be discussed in more detail using a specific example of data stored in the memory.

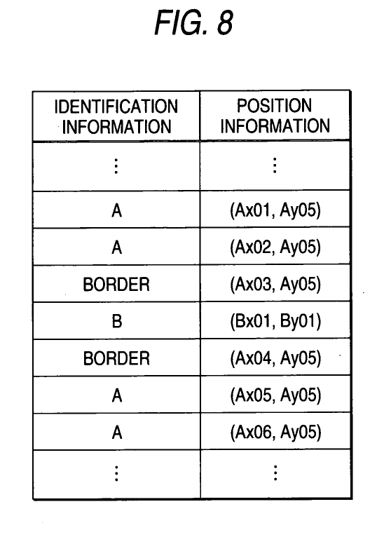

FIG. 8 shows an example of data stored in the memory when processing for the ranges 511a to 511j shown in FIG. 5 is performed.

Here, identification information “A” means identification information of the code-added document 510 and identification information “B” means identification information of the label 520. Identification information “Border” means the boundary between the code-added document 510 and the label 520.

As the position information, the following information is stored:

The position information following the coordinate system in the code-added document 510 is stored for the code-added document 510 and the boundary. For example, the position information with the upper left point of the code-added document 510 as the origin is stored. “A” as the prefix of the X coordinates and the Y coordinates indicates that the position information is position information in the code-added document 510 given the identification information “A.”

On the other hand, the position information following the coordinate system in the label 520 is stored for the label 520. For example, the position information with the upper left point of the label 520 as the origin is stored. “B” as the prefix of the X coordinates and the Y coordinates indicates that the position information is position information in the label 520 given the identification information “B.”

The processing in FIG. 6 applied to the ranges 511a to 511j will be discussed below specifically:

For the range 511a, identification information A and position information (Ax01, Ay05) are stored at step 807 and for the range 511b, identification information A and position information (Ax02, Ay05) are stored at step 807. For the ranges 511c to 511f, the code-added document 510 and the label 520 are mixed beyond a negligible extent and therefore it is determined at step 802 that the range cannot be shaped, and identification information and position information are not stored. Next, for the range 511g, identification information B and position information (Bx01, By01) are stored at step 807 and the identification information is not the same as the previous identification information and therefore the fact that there is a boundary between the previous range and the current range is stored at step 809.

That is, the fact that there is a boundary point between the position information (Ax02, Ay05) and the position information (Bx01, By01) is stored. Thus, if the previous range is on the code-added document 510 and the current range is on the label 520, letting the coordinates of the range immediately preceding the boundary point be P1 and the coordinates of the range preceding preceding the boundary point be P2, the boundary point coordinates P0 are found as follows: However, the expressions “immediately preceding” and “preceding preceding” are used except the ranges that cannot be shaped.
When the number of ranges that cannot be shaped is 0: P0=P1+(P1−P2)/2
When the number of ranges that cannot be shaped is one: P0=P1+(P1−P2)
When the number of ranges that cannot be shaped is two: P0=P1+(P1−P2)+(P1−P2)/2
When the number of ranges that cannot be shaped is three: P0=P1+(P1−P2)*2

Thus, generally, using the number of ranges that cannot be shaped, “e,” the boundary point coordinates P0 can be found according to “P0=P1+(P1−P2)*(e+1)/2.”

In the example in the embodiment, the number of ranges that cannot be shaped is four and therefore Ax03=Ax02+(Ax02-Ax01)*5/2.

For the range 511h, the code-added document 510 and the label 520 are mixed beyond a negligible extent and therefore it is determined at step 802 that the range cannot be shaped, and identification information and position information are not stored. Next, for the range 511i, identification information A and position information (Ax05, Ay05) are stored at step 807 and the identification information is not the same as the previous identification information and therefore the fact that there is a boundary between the previous range and the current range is stored at step 809.

That is, the fact that there is a boundary point between the position information (Bx01, By01) and the position information (Ax05, Ay05) is stored. In this case, however, the previous range is on the label 520 and the current range is on the code-added document 510 and the boundary point coordinates P0 are found after processing for the next range is performed. That is, for the range 511j, identification information A and position information (Ax06, Ay05) are stored at step 807 and the boundary point is found accordingly.

In this case, letting the coordinates of the range immediately following the boundary point be P1 and the coordinates of the range following following the boundary point be P2, the boundary point coordinates P0 are found as follows: However, the expressions “immediately following” and “following following” are used except the ranges that cannot be shaped.
When the number of ranges that cannot be shaped is 0: P0=P1−(P2−P1)/2
When the number of ranges that cannot be shaped is one: P0=P1−(P2−P1)
When the number of ranges that cannot be shaped is two: P0=P1−(P2−P1)−(P2−P1)/2
When the number of ranges that cannot be shaped is three: P0=P1−(P2−P1)*2

Thus, generally, using the number of ranges that cannot be shaped, e, the boundary point coordinates P0 can be found according to “P0=P1−(P2−P1)*(e+1)/2.”

In the example in the embodiment, the number of ranges that cannot be shaped is one and therefore Ax04=Ax05−(Ax06−Ax05)*2/2.

Next, the terminal 700 for acquiring the data shown in FIG. 8 and displaying the document object 710 and the label object 720 will be discussed.

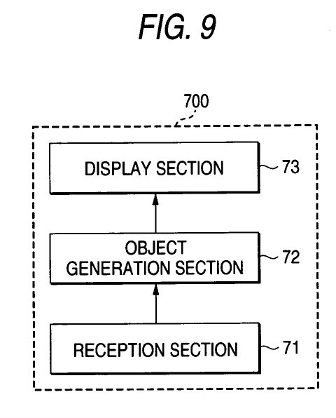

FIG. 9 is a block diagram to show the functional configuration of the terminal 700.

As shown in the figure, the terminal 700 includes a reception section 71, an object generation section 72, and a display section 73.

The reception section 71 receives information of scan points. The object generation section 72 generates the document object 710 and the label object 720 based on the received information. The display section 73 displays the generated document object 710 and the generated label object 720.

The described terminal 700 operates as follows:

First, the reception section 71 receives identification information and position information of scan points in a wireless or wired manner from the read device and passes the identification information and the position information to the object generation section 72.

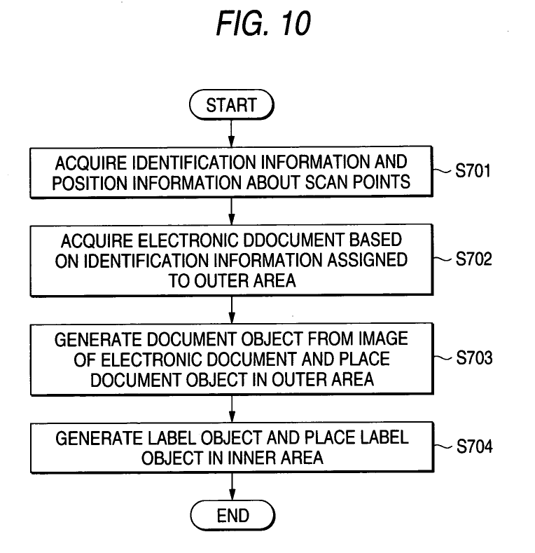

Accordingly, the object generation section 72 operates as shown in FIG. 10.

That is, the object generation section 72 acquires the identification information and the position information about the scan points and gives the identification information to the positions corresponding to the points in the memory as attribute for storage (step 701). For the points on the code-added document 510, the identification information is the identification information of the code-added document 510 and for the points on the label 520, the identification information is the identification information of the label 520. On the other hand, for the points on the boundary between the code-added document 510 and the label 520, the identification information is information indicating that the point is on the boundary (in FIG. 8, “Border”).

Next, the object generation section 72 determines the identification information given to each point in the outer area and acquires an electronic document with the identification information as a key (step 702). Since it is a common practice to put the label 520 inside the code-added document 510, the outer area is determined the code-added document 510. To acquire the electronic document, specifically the identification information in the outer area is transmitted to the identification information management server 200. Upon reception of the identification information, the identification information management server 200 acquires the corresponding electronic document from the document management server 300 and returns the electronic document to the terminal 700.

Then, the object generation section 72 generates the document object 710 from the image of the acquired electronic document and places the document object 710 in the outer area (step 703). At this time, the document object 710 is also placed in the area to which the identification information of the label 520 is given (inner area), and the object generation section 72 stores the range of the area.

On the other hand, the object generation section 72 generates the label object 720 and places the label object 720 in the stored inner area (step 704).

When the processing of the object generation section 72 is complete, last the display section 73 displays the placed objects on the screen. At the time, places the label object 720 is displayed at the front of the document object 710, so that it is made possible to reproduce the space placement relation also containing the top and bottom relation between the code-added document 510 and the label 520 on the electronic space.

If the user enters an operation command of separately selecting or moving the document object 710 or the label object 720 thus displayed, the document object 710 and the label object 720 can be processed separately in response to the operation. For example, if the user enters an operation command for the label object 720, an acceptance section (not shown) of the terminal 700 accepts the command and an operation execution section (not shown) executes the specified operation for the label object 720 independently of the document object 710.

In the embodiment, the full face of the code-added document 510 is read by the read device and an image is read by the processor 880 from the full face of the scan image, but processing need not necessarily be applied to the full face of the code-added document 510. That is, even if processing is applied to a part of the code-added document 510, position information of points on the boundary may be able to be found and accordingly the boundary line may be able to be determined.

As described above, in the embodiment, the position information of points on the code-added document 510 on which the label 520 is put is read by the read device and is processed. Thus, it is made possible to electronically recognize the position and the size of the label 520 put on the code-added document 510 and reproduce the positional relationship between the code-added document 510 and the label 520 on the electronic space.

### Second Embodiment

First, a code image used in the second embodiment will be discussed.

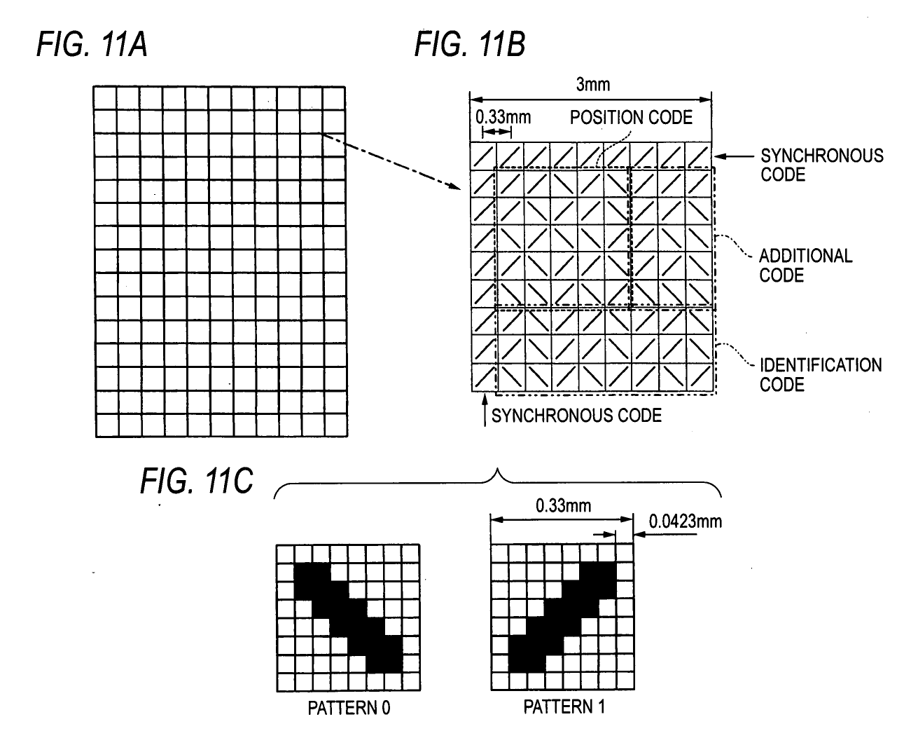

FIGS. 11A-11C are drawings to describe a two-dimensional code image printed on the printed material 500 in the second embodiment. FIG. 11A is a drawing represented like a lattice to schematically show the units of a two-dimensional code image formed of an invisible image and placed. FIG. 11B is a drawing to show one unit of the two-dimensional code image (two-dimensional code) whose invisible image is recognized by infrared application. Further, FIG. 11C is a drawing to describe slanting line patterns of a backslash and a slash.

The two-dimensional code in FIG. 3B described in the first embodiment contains the position code storing area, the identification code storing area, and the synchronous code storing area; the two-dimensional code in FIG. 11B also contains an area storing an additional code in addition to the areas.

In FIG. 11B, the position code is placed in a 5-bit×5-bit rectangular area. The bit values are formed as minute line bit maps different in rotation angle and slanting line patterns (patterns 0 and 1) shown in FIG. 11C represent bit values 0 and 1. More specifically, bits 0 and 1 are represented using a backslash and a slash which are different in inclination. Each slanting line pattern is of a size of 8×8 pixels in 600 dpi; the slanting line pattern lowering to the right (pattern 0) represents the bit value 0 and the slanting line pattern rising to the right (pattern 1) represents the bit value 1. Therefore, one slanting line pattern can represent 1-bit information (0 or 1). Using such minute line bit maps involving two types of inclinations, it is made possible to provide two-dimensional code patterns with extremely small noise given to a visible image, the two-dimensional code patterns in which a large amount of information can be digitized and embedded at a high density.

That is, 25-bit position information is stored in the position code area shown in FIG. 11B. Of the 25 bits, 12 bits can be used to code X coordinates and 12 bits can be used to code Y coordinates. The remaining one bit may be used for coding either the X or Y coordinates. If the 12 bits for the X coordinates and those for the Y coordinates are all used for coding positions, 212 (about 4096) positions can be coded. When each slanting line pattern is formed of 8×8 pixels (600 dpi) as shown in FIG. 11C, the size of the two-dimensional code (containing the synchronous code) in FIG. 11B becomes about 3 mm in length and about 3 mm in width (8 pixels×9 bits×0.0423 mm) because one dot of 600 dpi is 0.0423 mm. To code 4096 positions with a 3-mm spacing, a length of about 12 m can be coded. All 12 bits may be thus used to code positions or if a detection error of a slanting line pattern occurs, a redundancy bit for error detection and error correction may be contained.

The identification code is placed in a 3-bit×8-bit rectangular area and 24-bit identification information can be stored. To use 24 bits as the identification information, 224 (about 17 million) pieces of identification information can be represented. A redundancy bit for error detection and error correction can be contained in the 24 bits of the identification code like the position code.

On the other hand, the additional code is placed in a 5-bit×3-bit rectangular area and 15-bit additional information can be stored. To use 15 bits as the additional information, 215 (about 33000) pieces of additional information can be represented. A redundancy bit for error detection and error correction can be contained in the 15 bits of the additional code like the identification code and the position code.

In the embodiment, information of the medium size is stored in the additional code in the two-dimensional code having the composition. In so doing, the put range of the label 520 can be found without using a device for scanning over a wide range like the read device in the first embodiment. That is, the put range of the label 520 can be found simply by drawing a line across the code-added document 510 and the label 520.

Next, the specific configuration and operation of the embodiment will be discussed.

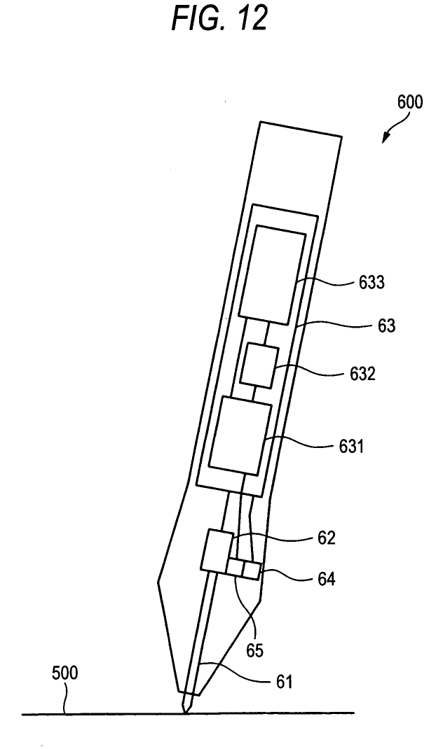

FIG. 12 is a drawing to show the configuration of the pen device 600 in the embodiment.

The pen device 600 includes a writing section 61 for recording text and a graphic form by similar operation to that of a usual pen on paper (medium) on which a code image and a document image are printed in combination, and a tool force detection section 62 for monitoring motion of the writing section 61 and detecting the pen device 600 pressed against paper. The pen device 600 also includes a control section 63 for controlling the whole electronic operation of the pen device 600, an infrared application section 64 for applying infrared light for reading a code image on paper, and an image input section 65 for recognizing and inputting the code image by receiving the reflected infrared light.

The control section 63 will be discussed in more detail.

The control section 63 includes a code acquisition section 631, a trace calculation section 632, and an information storage section 633. The code acquisition section 631 is a section for analyzing the image input from the image input section 65 and acquiring code and can be interpreted as an input section from the viewpoint of inputting code information. The trace calculation section 632 is a section for correcting the shift between the coordinates of the pen point of the writing section 61 and the coordinates of the image captured by the image input section 65 for the code acquired by the code acquisition section 631 and calculating the trace of the pen point. The information storage section 633 is a section for storing the code acquired by the code acquisition section 631 and the trace information calculated by the trace calculation section 632. A section for performing boundary recognition processing (described later) in the control section 63 can also be interpreted as a processing section although it is not shown.

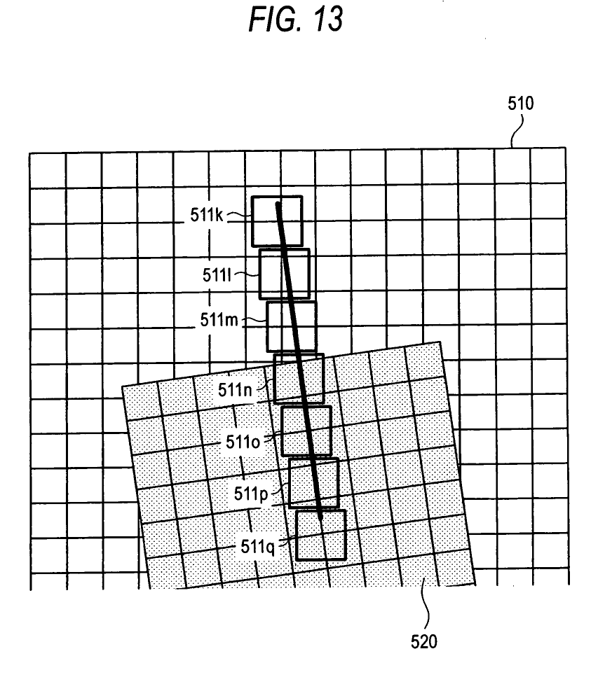

Boundary recognition processing when the pen device 600 is used will be discussed with reference to a specific example in FIG. 13.

FIG. 13 shows a state in which the label 520 is put on the code-added document 510. Here, the label 520 is shaded. The label 520 usually is put in an offhand manner and thus is drawn with a slight inclination (angle) relative to the code-added document 510. Each of the partitions provided in the code-added document 510 and the label 520 indicates the range of the two-dimensional code containing the synchronous code, the identification code, the position code, and the additional code shown in FIG. 11B.

In the embodiment, the boundary between the code-added document 510 and the label 520 is grasped as shown in the figure. That is, ranges 511k to 511q are ranges grasped by the pen device 600 along the trace and the images in the ranges are read in order.

The boundary recognition method in the embodiment is roughly as follows.

Which of the code-added document 510 and the label 520 exists in each range is determined from the identification information recognized in each range. The position where the identification information representing the code-added document 510 switches to that representing the label 520 or the identification information representing the label 520 switches to that representing the code-added document 510 is recognized as the boundary between the code-added document 510 and the label 520.

Putting the label 520 on the code-added document 510 at a given angle can normally occur as described above. In this case, the angle can be corrected using a similar method to that described in the first embodiment for reading information.

Also in the second embodiment, depending on the scan range, it is also considered that the code image of the code-added document 510 and the code image of the label 520 having a given angle may be mixed in the scan range. In this case, it is difficult to correct the angle and thus processing is advanced by assuming that it is impossible to correct the angle in such a range.

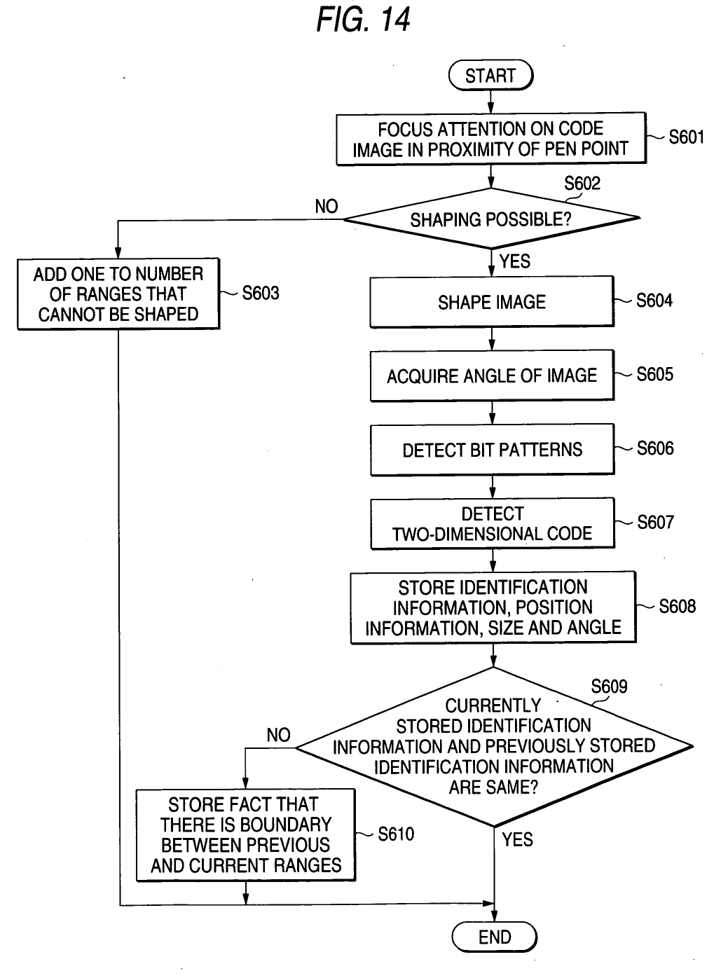

FIG. 14 is a flowchart to show processing executed mainly by the control section 63 of the pen device 600. When text or a graphic form is recorded on paper, for example, using the pen device 600, a detection signal indicating that recording on paper is performed using the pen is sent from the tool force detection section 62 to the control section 63. Upon reception of the detection signal, the control section 63 starts the operation in FIG. 14.

First, the control section 63 focuses attention on a code image in the proximity of the pen point (step 601). That is, when the infrared application section 64 applies infrared light onto paper in the proximity of the pen point, the infrared light is absorbed in a code image and is reflected on other portions. The image input section 65 receives the reflected infrared light and recognizes the portion where the infrared light is not reflected as the code image. Accordingly, the control section 63 focuses attention on the code image.

Next, the control section 63 determines whether or not the code image on which attention is focused can be shaped (step 602). Here, although the shaping includes angle correction, noise removal, etc., particularly whether or not it is impossible to correct the angle as the code-added document 510 and the label 520 are mixed in one range is determined.

If it is determined that shaping is impossible, one is added to the number of ranges that cannot be shaped (step 603). That is, letting a variable storing the number of ranges that cannot be shaped be e, the variable e represents the number of consecutive ranges determined where shaping is impossible.

On the other hand, if it is determined that shaping is possible, the control section 63 shapes the image (step 604). At this time, in the embodiment, the angle of the image is acquired (step 605). The control section 63 detects bit patterns (slanting line patterns) of slash, backslash and the like, from the shaped scan image (step 606). The control section 63 detects a two-dimensional code from the shaped scan image by detecting and referencing the synchronous code of the positioning code (step 607). Then, the control section 63 extracts and decodes information of ECC (Error Correction Code), etc., from the two-dimensional code and extracts identification information, position information, and additional information from the decoded information and stores the identification information, the position information, size information obtained from the additional information, and the information of the angle acquired at step 605 in memory (step 608). The identification information, the position information, and the additional information may be acquired from the scan image according to the method described in FIGS. 7A and 7B.

Since the identification information, the position information, the size, and the angle are also extracted and are stored in the memory by similar processing from the immediately preceding range, whether or not the currently stored identification information and the previously stored identification information are the same is determined (step 609). The term “previous(ly)” is used to means the previous process range except the ranges that cannot be shaped.

If the currently stored identification information and the previously stored identification information are not the same, the fact that there is a boundary between the previous range and the current range is stored in the memory (step 610). At the time, the boundary position on the medium where the previous and previous ranges exist is also found based on the previous position information and the previous position information and the found boundary position is stored. The boundary position on the medium where the current and following ranges exist is also found based on the current position information and the following position information.

On the other hand, if the currently stored identification information and the previously stored identification information are the same, both the previous and current ranges exist on the code-added document 510 or the label 520 and therefore the processing in the current range is terminated.

Next, the processing in FIG. 14 will be discussed in more detail using a specific example of data stored in the memory.

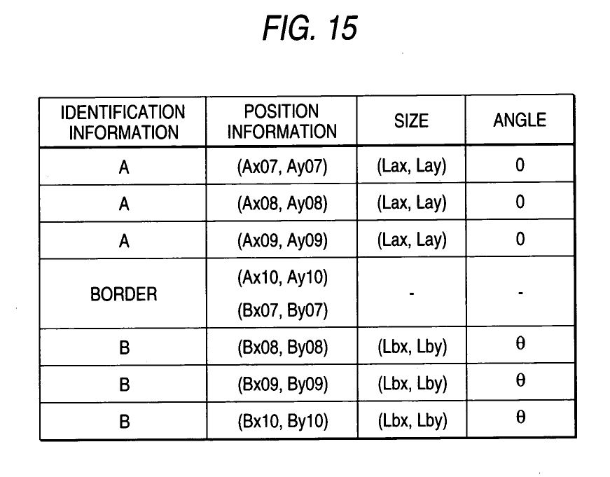

FIG. 15 shows an example of data stored in the memory when processing for the ranges 511k to 511q shown in FIG. 13 is performed.

Here, identification information “A” means identification information of the code-added document 510 and identification information “B” means identification information of the label 520. Identification information “Border” means the boundary between the code-added document 510 and the label 520.

As the position information, the following information is stored.

The position information following the coordinate system in the code-added document 510 is stored for the code-added document 510 and the boundary. For example, the position information with the upper left point of the code-added document 510 as the origin is stored. “A” as the prefix of the X coordinates and the Y coordinates indicates that the position information is position information in the code-added document 510 given the identification information “A.”

On the other hand, the position information following the coordinate system in the label 520 is stored for the label 520. For example, the position information with the upper left point of the label 520 as the origin is stored. “B” as the prefix of the X coordinates and the Y coordinates indicates that the position information is position information in the label 520 given the identification information “B.”

For the boundary, both the position information following the coordinate system in the code-added document 510 and the position information following the coordinate system in the label 520 are stored.

The information of the size of each medium obtained from the additional information is also stored in the memory. That is, for the code-added document 510, Lax is stored as the length in the X direction and Lay is stored as the length in the Y direction. For the label 520, Lbx is stored as the length in the X direction and Lby is stored as the length in the Y direction.

Further, the information of the angle of each medium is also stored in the memory. Here, angle 0 is stored for the code-added document 510, and angle θ is stored for the label 520.

The processing in FIG. 14 applied to the ranges 511k to 511q will be discussed below specifically:

For the range 511k, identification information A, position information (Ax07, Ay07), the size (Lax, Lay), and the angle 0 are stored at step 608; for the range 511l, identification information A, position information (Ax08, Ay08), the size (Lax, Lay), and the angle 0 are stored at step 608; and for the range 511m, identification information A, position information (Ax09, Ay09), the size (Lax, Lay), and the angle 0 are stored at step 608. For the range 511n, the code-added document 510 and the label 520 are mixed beyond a negligible extent and therefore it is determined at step 602 that the range cannot be shaped, and identification information, position information, size, and angle are not stored. Next, for the range 511o, identification information B, position information (Bx08, By08), the size (Lbx, Lby), and the angle θ are stored at step 608 and the identification information is not the same as the previous identification information and therefore the fact that there is a boundary between the previous range and the current range is stored at step 610.

That is, the fact that there is a boundary point between the position information (Ax09, Ay09) and the position information (Bx08, By08) is stored. In the embodiment, as the boundary point coordinates P0, the coordinates on the medium where the previous range exists and the coordinates on the medium where the current range exists are found.

First, letting the coordinates of the range immediately preceding the boundary point be P1, the coordinates of the range preceding preceding the boundary point be P2, and the number of ranges that cannot be shaped be e, the boundary point coordinates P0 on the medium where the previous range exists are found according to “P0=P1+(P1−P2)*(e+1)/2.”

In the example in the embodiment, the number of ranges that cannot be shaped is one and therefore Ax10=Ax09+(Ax09−Ax08)*2/2, Ay10=Ay09+(Ay09−Ay08)*2/2.

Letting the coordinates of the range immediately following the boundary point be P1, the coordinates of the range following the boundary point be P2, and the number of ranges that cannot be shaped be e, the boundary point coordinates P0 on the medium where the current range exists are found according to “P0=P1−(P2−P1)*(e+1)/2.”

In the example in the embodiment, the number of ranges that cannot be shaped is one and therefore Bx07=Bx08−(Bx09−Bx08)*2/2, By07=By08−(By09−By08)*2/2. Since (Bx09, By09) is not found at this point in time, the calculation is performed after (Bx09, By09) is found in the next processing.

That is, for the range 511p, identification information B, position information (Bx09, By09), the size (Lbx, Lby), and the angle 0 are stored at step 608. Last, for the range 511q, identification information B, position information (Bx10, By10), the size (Lbx, Lby), and the angle θ are stored at step 608.

Next, the terminal 700 for acquiring the data shown in FIG. 15 and displaying the document object 710 and the label object 720 will be discussed.

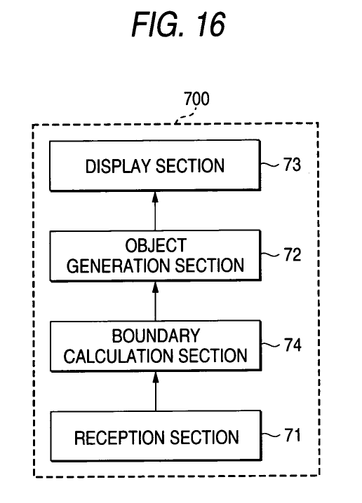

FIG. 16 is a block diagram to show the functional configuration of the terminal 700.

As shown in the figure, the terminal 700 includes a reception section 71, a boundary calculation section 74, an object generation section 72, and a display section 73.

The functions of the reception section 71, the object generation section 72, and the display section 73 are similar to those in the first embodiment. The terminal 700 differs from the terminal 700 in the first embodiment only in that it includes the boundary calculation section 74. The boundary calculation section 74 calculates and finds the boundary between the code-added document 510 and the label 520 based on the information received by the reception section 71.

The described terminal 700 operates as follows.

First, the reception section 71 receives identification information, position information, sizes, and angles of scan points in a wireless or wired manner from the pen device 600 and passes the identification information, the position information, the sizes, and the angles to the boundary calculation section 74.

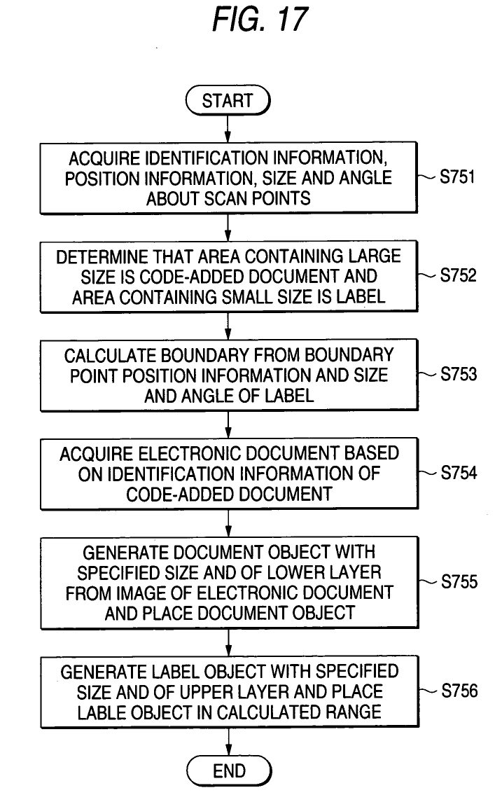

Accordingly, the boundary calculation section 74 and the object generation section 72 operate as shown in FIG. 17.

That is, the object generation section 72 acquires the identification information, the position information, the sizes, and the angles about the scan points (step 751). For the points on the code-added document 510, the identification information is the identification information of the code-added document 510 and for the points on the label 520, the identification information is the identification information of the label 520. On the other hand, for the points on the boundary between the code-added document 510 and the label 520, the identification information is information indicating that the point is on the boundary (in FIG. 15, “Border”).

Next, the boundary calculation section 74 makes a comparison between two pieces of the size information and determines that the large one is the code-added document 510 and the small one is the label 520 (step 752). The boundary calculation section 74 calculates a boundary using the boundary point position information and the size and the angle of the label 520 (step 753). That is, the coordinates of the boundary point on the code-added document 510 are known and the coordinates of the boundary point on the label 520 are also known and thus the coordinates of the origin of the position information on the label 520 on the code-added document 510 are also known. Therefore, if a label 520 with the specified size and angle is drawn on the code-added document 510 with the origin as the reference, the range in which the label 520 is put can be reproduced.

When the put range of the label 520 is found, the object generation section 72 acquires an electronic document with the identification information of the code-added document 510 (identification information corresponding to the large size) as a key (step 754). To acquire the electronic document, specifically the identification information corresponding to the large size is transmitted to the identification information management server 200. Upon reception of the identification information, the identification information management server 200 acquires the corresponding electronic document from the document management server 300 and returns the electronic document to the terminal 700.

Then, the object generation section 72 generates the document object 710 with the specified size and of the lower layer from the image of the acquired electronic document and places the document object 710 (step 755).

On the other hand, the object generation section 72 generates the label object 720 with the specified size and of the upper layer and places the label object 720 in the range calculated at step 753 (step 756).

When the processing of the object generation section 72 is complete, last the display section 73 displays the placed objects on the screen. At the time, places the label object 720 is displayed at the front of the document object 710, so that it is made possible to reproduce the space placement relation also containing the top and bottom relation between the code-added document 510 and the label 520 on the electronic space.

If the user enters an operation command of separately selecting or moving the document object 710 or the label object 720 thus displayed, the document object 710 and the label object 720 can be processed separately in response to the operation. For example, if the user enters an operation command for the label object 720, an acceptance section (not shown) of the terminal 700 accepts the command and an operation execution section (not shown) executes the specified operation for the label object 720 independently of the document object 710.

In the embodiment, only one line is written across the boundary between the code-added document 510 and the label 520 with the pen device 600, but the number of lines is not limited to one and two or more lines may be written.

In the embodiment, the pen device 600 performs processing of acquiring the position information of one point on the boundary and the size and angle information of the label 520, and the terminal 700 performs processing of generating the objects using the information. However, to which part the pen device 600 shares the processing sequence from the boundary recognition to the object generation and from which part the terminal 700 shares can be determined arbitrarily.

As described above, in the embodiment, the position information of one point on the boundary between the code-added document 510 and the label 520 and the size and angle information of the label 520 are read and are processed with the pen device 600. Accordingly, it is made possible to electronically recognize the position and the size of the label 520 put on the code-added document 510 and reproduce the positional relationship between the code-added document 510 and the label 520 on the electronic space.

The first embodiment and the second embodiment have been described, but the invention is not limited to the specific embodiments.

For example, the identification information contained in the code image is described as the information for uniquely identifying each medium, but may be information for uniquely identifying the electronic document printed on each medium.

In the embodiment, a code image is also printed on the label 520 and a boundary is recognized based on discontinuity between information represented by the code image on the code-added document 510 and information represented by the code image on the label 520. However, a modified example wherein no code image is printed on the label 520 is also possible. In this case, a boundary can be recognized by detecting that the information represented by the code image on the code-added document 510 breaks off at the put position of the label 520.

As described with reference to the embodiments, according to the present invention, there is provided a configuration that enables the user to electronically recognize the position and the size of an adhesive material put on a base material.

The invention is not limited to the embodiments described above, and various modifications are possible without departing from the spirit and scope of the invention. The components of the embodiments can be combined with each other arbitrarily without departing from the spirit and scope of the invention.

The entire disclosure of Japanese Patent Application No. 2005-267373 filed on Sep. 14, 2005 including specification, claims, drawings and abstract is incorporated herein by reference in its entirety.

What is claimed is:

1. An arrangement reproduction method comprising:
reading a first code image on a first medium and a second code image on a second medium arranged on the first medium;
recognizing an arrangement range in which the second medium is arranged on the first medium using the first code image and the second code image; and
reproducing on an electronic space the arrangement relationship between the first medium and the second medium including the recognized arrangement range.

2. The arrangement reproduction method according to claim 1, wherein the code image includes a position code indicating a coordinate position on the medium, and in the recognizing step, the arrangement range is recognized using position information of a plurality of discontinuous portions between the position code of the first code image and the position code of the second code image, the discontinuous portions being formed by arrangement of the second medium on the first medium.

3. The arrangement reproduction method according to claim 1, wherein the code image includes a position code indicating a coordinate position on the medium and the second code image further includes size information of the second medium, and in the recognizing step, the arrangement range is recognized using position information of discontinuous portions between the position code of the first code image and the position code of the second code image, and the size information of the second medium.

4. The arrangement reproduction method according to claim 1, wherein in the recognizing step, additional information to the first medium or the second medium is further recognized using the first code image or the second code image, and
wherein in the reproducing step, the additional information is further reproduced.

5. The arrangement reproduction method according to claim 1, wherein in the reproducing step, a first object representing the first medium is displayed and a second object representing the second medium is displayed in a range corresponding to the arrangement range on the first object, to reproduce the arrangement relationship.

6. The arrangement reproduction method according to claim 5, wherein in the reproducing step, the second object is displayed at the front of the first object, whereby the arrangement relationship containing a hierarchical relation between the first medium and the second medium is reproduced.

7. The arrangement reproduction method according to claim 5, wherein in the reproducing step, the first object and the second object are managed to be separately operable.

8. A scanner apparatus comprising:
an input section that inputs first information printed on a first medium containing position information within the first medium and second information printed on a second medium arranged on the first medium; and
a processing section that recognizes an arrangement range in which the second medium is arranged on the first medium using the position information of a discontinuous portion between the first information and the second information.

9. The scanner apparatus according to claim 8, wherein the position information includes a position code indicating a coordinate position on the medium, the discontinuous portions being formed by arrangement of the second medium on the first medium.

10. The scanner apparatus according to claim 8, wherein the first information and the second information further includes identification information for identifying the first medium and the second medium, and the processing section compares identification information of the first medium with identification information of the second medium, to determine the discontinuous portion.

11. The scanner apparatus according to claim 8, wherein the processing section compares position information in the first medium contained in the first information with position information of the second medium contained in the second information, to determine the discontinuous portion.

12. The scanner apparatus according to claim 8, wherein the processing section recognizes the arrangement range using the position information of a plurality of the discontinuous portions.

13. The scanner apparatus according to claim 8, wherein the second information further includes size information of the second medium, and the processing section recognizes the arrangement range further using size information of the second medium.

14. A storage medium readable by a computer, the storage medium storing a program of instructions executable by the computer to perform a function, the function comprising:
inputting code information printed on a base material on which an adhesive material is arranged, the code information includes a position code indicating a coordinate position on the base material; and
recognizing an arrangement range in which the adhesive material is arranged on the base material using position information of a part where continuity of the code information is interrupted by arrangement of the adhesive material on the base material.

15. The storage medium according to claim 14, wherein on the adhesive material, the code information including a position code indicating a coordinate position on the adhesive material is printed, and the code information printed on the adhesive material is further input in the inputting step, and wherein in the recognizing step, the part where the continuity of the code information is interrupted is determined using the code information printed on the base material and the code information printed on the adhesive material.

16. A storage medium readable by a computer, the storage medium storing a program of instructions executable by a computer to perform a function, the function comprising:
acquiring position information on a first medium at an edge of a second medium arranged on a first medium;
calculating an arrangement range in which the second medium is arranged on the first medium based on the position information; and
arranging a second object representing the second medium in a range corresponding to the arrangement range on a first object representing the first medium.

17. The storage medium according to claim 16, the function further comprising:
accepting an operation command for the second object; and
performing the operation command for the second object independently from the first object.

18. A storage medium readable by a computer, the storage medium storing a program of instructions executable by a computer to perform a function, the function comprising:
acquiring first information indicating the position on a first medium of at least one point on an edge of a second medium arranged on the first medium, second information indicating a size of the second medium, and third information indicating an inclination of the second medium relative to the first medium;
calculating an arrangement range in which the second medium is arranged on the first medium based on the first information, the second information, and the third information; and
arranging a second object representing the second medium in a range corresponding to the arrangement range on a first object representing the first medium.

19. The storage medium according to claim 18, the function further comprising:
accepting an operation command for the second object; and
performing the operation command for the second object independently from the first object.

20. An arrangement reproduction method comprising:
a step for reading a first code image on a first medium and a second code image on a second medium arranged on the first medium;
a step for recognizing an arrangement range in which the second medium is arranged on the first medium using the first code image and the second code image; and
a step for reproducing on an electronic space the arrangement relationship between the first medium and the second medium including the recognized arrangement range.

21. A scanner apparatus comprising:
an input means for inputting first information printed on a first medium containing position information within the first medium and second information printed on a second medium arranged on the first medium; and
a processing means for recognizing an arrangement range in which the second medium is arranged on the first medium using the position information of a discontinuous portion between the first information and the second information.
